(19) United States
(12) Patent Application Publication
(10) Pub. No.: US 2015/0334461 A1
(43) Pub. Date: Nov. 19, 2015

(54) Methods and systems for dynamically recommending favorite channels or programs

(71) Applicant: Looq System Inc., Santa Clara, CA (US)

(72) Inventor: Woody Yu, Santa Clara, CA (US)

(73) Assignee: Looq System Inc., Santa Clara, CA (US)

(21) Appl. No.: 14/120,314

(22) Filed: May 14, 2014

(51) Int. Cl. H04N 21/466; H04N 21/442; H04N 21/45

(52) U.S. Cl. CPC H04N 21/4668; H04N 21/4667; H04N 21/4532; H04N 21/44204; H04N 21/44222

(57) ABSTRACT

A method for dynamically recommending favorite channels or programs, implemented on a computer and a non-transitory computer-readable storage medium, comprises the following steps: collecting historical data of a user's operations; classifying the historical data; determining a ranking of channels or programs in each class; querying current or future broadcast information; matching the broadcast information with the ranking of channels or programs; and recommending to the user a favorite channel or program list with a predetermined degree of match.

### FIELD

The present disclosure relates to the field of information processing, and particularly to a method and a system for dynamically recommending favorite channels or programs.

### BACKGROUND

At present, in the field of audio-video/on-demand broadcasting, more and more service providers have already paid attention to the setting to provide personalized selections. For example, either a set-top box or a TV set remote controller is equipped with several keys for recording users' favorite channels or programs. However, due to the limitation of the remote controller space, the arranged few keys are unlikely to provide rich selections. So usually a user needs to manually perform combination configurations. Such configuration procedure is usually relatively complicated. Additionally, favorite channels or programs are unlikely to be unified and fixed at few combinations in the case that there are many family members. Therefore, very few people proceed to configure so that almost no person switches his own favorite channels or programs by using relevant keys on a conventional remote controller.

In addition, advanced apparatuses in the prior art may support remote control operation of a mobile device. A mobile device usually may customize a graphic user interface, and a remote controller based on this has a relatively friendly operation interface. A graphical user interface-based operating system may configure many kinds of combinations of favorite channels or programs. However, this configuration still requires manual operations. The more the combinations, the more manual operations are needed. It takes a lot of time to match a large number of specific channels or programs with preference operations/buttons. The user needs to memorize these matches, and channel/program changes require manual settings and memorization.

### SUMMARY

In one aspect, a method for dynamically recommending favorite channels or programs, implemented on a computer and a non-transitory computer-readable storage medium, comprises collecting historical data of a user's operations; classifying the historical data; determining a ranking of channels or programs in each class; querying broadcast information; matching the broadcast information with the ranking of channels or programs; and recommending a favorite channel or program list with a predetermined degree of match.

In another aspect, a system for dynamically recommending favorite channels or programs comprises a computer and a non-transitory computer-readable storage medium configured to include: a collecting module configured to collect historical data of a user's operations; a ranking module configured to classify the historical data and determine a ranking of channels or programs in each class; a querying module configured to periodically query broadcast information; a matching module configured to match the broadcast information with the ranking of channels or programs; and a recommending module configured to recommend a favorite channel or program list with a predetermined degree of match.

In yet another aspect, a non-transitory computer-readable storage medium, comprises computer program codes stored thereon, executable by computer. The computer program codes comprise: instructions for collecting historical data of a user's operations; instructions for classifying the historical data; instructions for determining a ranking of channels or programs in each class; instructions for querying broadcast information periodically; instructions for matching the broadcast information with the ranking of channels or programs; and instructions for recommending a favorite channel or program list with a predetermined degree of match.

### BRIEF DESCRIPTION OF DRAWINGS

FIG. 1 illustrates a flowchart of a method for dynamically recommending favorite channels or programs according to one embodiment of the present disclosure.

FIG. 2 illustrates a block diagram showing module structure of a system for dynamically recommending favorite channels or programs according to one embodiment of the present disclosure.

### DESCRIPTION OF THE DISCLOSURE

The present disclosure provides a method and a system on how to automatically complete customization of favorite channels or programs.

In one aspect, a method for dynamically recommending favorite channels or programs, implemented on a computer and a non-transitory computer-readable storage medium, comprises the following steps:

S1: collecting historical data of a user's operations;

S2: classifying the historical data and determining a ranking of channels or programs in each class;

S3: querying current or future broadcast information periodically;

S4: matching the broadcast information with the ranking; and

S5: recommending a favorite channel list with a predetermined degree of match.

In one embodiment, at step S2, each channel or program in the historical data is classified according to dates and time periods when the user watches the program.

In one embodiment, at step S2, channels and programs in each class are ranked according to a user's preference degree.

In one embodiment, at step S4, a current broadcast information is matched with the ranking of channels or programs.

In one embodiment, at step S5, the favorite channel list is recommended according to a degree of match between the ranking of channels or programs and a current and a next broadcast information.

In another aspect, the present disclosure provides a system for dynamically recommending favorite channels or programs. The system comprises a computer and a non-transitory computer-readable storage medium configured to include:

a collecting module configured to collect historical data of a user's operations;

a ranking module configured to classify the historical data and determine a ranking of channels and programs in each class;

a querying module configured to periodically query current and future broadcast information;

a matching module configured to match the broadcast information with the ranking; and

a recommending module configured to recommend to the user a favorite channel list with a predetermined degree of match.

In one embodiment, the ranking module further comprises a fine classification module configured to classify each channel or program in the historical data according to dates and time periods when the user watches the program.

In one embodiment, the ranking module further comprises a calculating module configured to rank channels and programs in each class configured to rank channels and programs in each class according to a user's preference degree.

In one embodiment, the matching module further comprises a real-time matching module configured to match the current broadcast information with the ranking of the channels or programs.

In one embodiment, the recommending module further comprises a comprehensive recommending module configured to recommend the favorite channel list according to a predetermined degree of match between the current and next broadcast information with the ranking of the channels or programs.

In yet another aspect, a non-transitory computer-readable storage medium, comprises computer program codes stored thereon, executable by computer. The computer program codes comprise: instructions for collecting historical data of a user's operations; instructions for classifying the historical data; instructions for determining a ranking of channels or programs in each class; instructions for querying broadcast information periodically; instructions for matching the broadcast information with the ranking of channels or programs; and instructions for recommending a favorite channel or program list with a predetermined degree of match.

The present disclosure provides a method and a system for dynamically recommending favorite channels or programs. Precise recommendation of the user's preferences is accomplished automatically by analyzing and studying the historical data of the user's operations, so that the user does not need to perform preference setting manually and to memorize setting combinations. The favorite channels and programs may be precisely selected and viewed only by pressing a few buttons, thereby users' operation and enhancing users' enjoyment.

### DETAILED DESCRIPTION OF PREFERRED EMBODIMENTS

Embodiments of the present disclosure are described with reference to figures. The depicted embodiments are embodiments for implementing the present invention. The depictions aim to describe general principles of the present invention, not to limit the scope of the present invention. The protection scope of the present invention should be subjected to what are defined by the appended claims. All other embodiments obtained by those having ordinary skill in the art based on embodiments of the present invention without making inventive efforts fall within the protection scope of the present invention.

A sole purpose of a TV set remote controller is to help a user to find his own favorite channels or programs. An operating system interface based on the remote control manner of a handset is more convenient than the conventional TV set remote controller, but there are still many drawbacks. For example, there are many aspects that need to be manually set and memorized by the user. In real life situations, remote control is merely a means, and the user's final purpose is to watch his own favorite channels or programs timely. From the extremist perspective, what is desired by the user is to directly watch his favorite channels or programs upon pressing a key, and he will not and does not want to care about how to implement this.

Besides convenient operations of the graphical user interface, the most important aspect that can be provided by a mobile device is to invoke an application program with a complicated function. By using embedded applications, the present invention achieves the goal of automatic setting, updating and invoking of a user's favorite list and thereby completes dynamic recommendation of favorite channels or programs according to each user's individual needs.

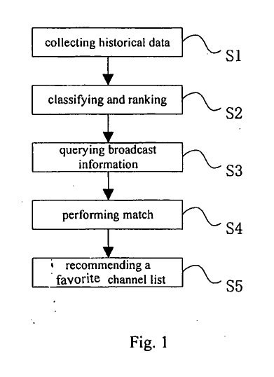

Referring to FIG. 1, the method for dynamically recommending favorite channels or programs according to one embodiment of the present disclosure comprises the following steps:

S1: collecting historical data of a user's operations;

S2: classifying the historical data and determining a ranking of channels or programs in each class;

S3: querying current and future broadcast information periodically;

S4: matching the broadcast information with the ranking of channels or programs; and

S5: recommending to the user a favorite channel or program list with a predetermined degree of match.

Wherein at step S1, channels or programs often viewed by the user are mostly collected to prevent the historical data from being too massive. In one embodiment, what are collected here are channels or programs that are viewed by the user for more than three minute once. Certainly, those skilled in the art may also decide to collect channels or programs viewed longer than other time periods according to the user's actual situations, which are not specifically limited here.

At step S2, each channel or program in the historical data is classified according to dates and time periods when the user watches the program. Since a majority of fixed programs are broadcast at fixed time period daily or weekly, preferably coarse classification is performed with one week as a cycle, and then fine classification is performed by each time period of each day. A granularity of fine classification may be set according to the needs of recommended precision, for example, where the user prefers TV plays, the fine classification will be performed by a usual length of one episode of a TV play, more specifically, 45 minutes or one hour (with advertisement time considered) is regarded as a time period; again for example, where the user prefers US programs, 15 minutes (a cycle for inserting an advertisement) is regarded as a time period. Certainly, those skilled in the art may also use other time periods as a classification granularity, but meanwhile, in order to avoid an excessively large processing workload, the fine classification granularity is preferably above five minutes. Then, channels and programs in each class are ranked according to a user's preference degree, for example, in the same time period, a program most frequently watched recently has the highest degree, a channel with the longest accumulated view duration has the second highest degree, and so on so forth, thereby determining the ranking of channels and programs in each time period. Preferably, to save resources, only channels and programs ranking closer to the highest can be determined, and those ranking below a certain level will not be taken into account during statistics.

At step S3, the broadcast information is a program broadcast scheduled at all channels in a future time period. A query cycle is selected according to situations of disclosure of the broadcast information. Preferably, the broadcast information in the future one week is queried once each day. Upon query, the query content includes a broadcast date, a broadcast starting time, a broadcast finishing time, a broadcast length, and names of TV channels and types of programs. Other relevant information may also be queried according to the user's different demands.

At step S4, the broadcast information is matched with the ranking of step S2 according to the current time, namely, judging a match degree between programs at each channel currently being broadcast or to be imminently broadcast and each program in the ranking under the same class (namely, belonging to the same time period). The step needs to analyze programs and channels that the user likes most currently in the current time period. Since the channels and programs viewed by the user are different at different dates of one week or different time periods of one day, the step needs to dynamically analyze corresponding preference programs and channels in different time periods, with date and time factors being taken into account. For example, if, at nine o'clock on Saturday night, what is ranked at the highest at step S2 is program a of channel A, and the broadcast information also includes program a of channel A in this time period, the match is will be recorded as an optimal complete match; if the broadcast information does not include program a of channel A in this time period, other match situations with programs similar to program a will be considered, or a match situation with program b of cannel B ranking the second will be taken into account.

At step S5, a favorite channel list with a predetermined degree of match is recommended to the user according to the match situations of step S4, and the user chooses to view by pressing a key according to the recommended list. It is feasible that recommendation is performed for the complete match situation according to the levels in the ranking, and usually this can be processed easily. In event of incomplete match, recommendation is comprehensively performed according to the levels in the ranking and corresponding match degrees. To avoid the list being too lengthy thereby causing difficulty to the user in selection and inconvenience in operation, only three favorite channels may be displayed as a preferred embodiment herein. A list including other number of channels may also be set and will not be specifically limited herein.

The favorite channel list may be displayed in an electronic screen, or displayed in other manners to facilitate the user's observation. Besides, as viewed from a relatively precise time period, when the broadcast time of the user's most favorite program is not reached currently and the current recommendation is not necessarily the most preferred one for next time period, the current recommendation may be displayed first and the user is reminded when said next time period comes; or the user's most preferred one for said next time period is directly displayed in the current recommendation simultaneously. More preferably, the recommendation for said next time period may be displayed distinctively, for example, a prompt is presented in a different typeface or color upon simultaneous display.

Since embodiments of the present invention may perform accurate recommendation automatically, after the recommended channels are controlled in a certain number, direct switchover may be achieved by using very few buttons so that the interface and user operation mode can be further simplified. For instance, upon entering the three recommended channels, it is completely feasible that only one button is provided, the user switch the channel once by pressing it once, and this can be done cyclically. For visual and eye-catching purpose, only one big button may be prepared, a current channel logo is directly displayed on the button, and the logo changes once when the button is pressed once. By using the manner in the embodiment of the present invention, a user having a fixed viewing habit by no means needs to manually perform preference settings and to memorize setting combinations. The favorite channels and programs may be precisely selected and viewed only by pressing one button, thereby substantially simplifying the users' operation and enhancing users' enjoyment.

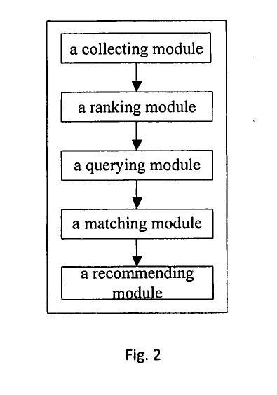

Those having ordinary skill in the art may appreciate that all or partial steps of the method according to the above embodiments may be performed by a program to instruct relevant hardware to fulfill. Said program may be stored in a computer-readable storage medium. When the program is executed, all steps of the method in the above embodiments are performed. The storage medium may be a ROM/RAM, magnetic disk, optical disk, memory card or the like. Hence, referring to FIG. 2, corresponding to the above method, the present disclosure discloses a system for dynamically recommending favorite channels or programs, comprising:

a collecting module configured to collect historical data of the user's operations;

a ranking module configured to classify the historical data and determine a ranking of channels or programs in each class;

a querying module configured to periodically query future broadcast information;

a matching module configured to match the broadcast information with the ranking; and

a recommending module configured to recommend to the user a favorite channel list with a predetermined degree of match.

The present invention provides a method and system for dynamically recommending favorite channels or programs. Precise recommendation of the user's preferences is accomplished automatically by analyzing and studying the historical data of the user's operations, so that the user does not need to perform preference setting manually and to memorize setting combinations. The favorite channels and programs may be precisely selected and viewed only by pressing a few buttons, thereby substantially simplifying the user operation and enhancing users' enjoyment.

The above description illustrates and depicts several preferred embodiments. As stated above, it should be appreciated that the present invention is not limited to the forms revealed in the text, and should not be considered as excluding other embodiments. The present invention may be used for various other combinations, modifications and environments, and can be modified through the above teaching or technologies or knowledge in the relevant fields within the scope of inventive concept of the text. Any modifications and variations made by those skilled in the art all should be regarded as falling within the protection scope defined by the appended claims of the present invention so long as they do not depart from the spirit and scope of the present invention.

1. A method for dynamically recommending favorite channels or programs, implemented on a computer and a non-transitory computer-readable storage medium, comprising:
collecting historical data of a user's operations;
classifying the historical data;
determining a ranking of channels or programs in each class;
querying broadcast information periodically;
matching the broadcast information with the ranking of channels or programs; and
recommending a favorite channel or program list with a predetermined degree of match.

2. The method according to claim 1, wherein each channel or program in the historical data is classified according to dates and time periods when the user watches the program.

3. The method according to claim 1, wherein channels and programs in each class are ranked according to a user's preference degree.

4. The method according to claim 1, wherein a current broadcast information is matched with the ranking of channels or programs.

5. The method according to claim 1, wherein the favorite channel list is recommended according to a degree of match between a current and a next broadcast information and the ranking of channels or programs.

6. A system for dynamically recommending favorite channels or programs, comprising:
a computer and a non-transitory computer-readable storage medium configured to include:
a collecting module configured to collect historical data of a user's operations;
a ranking module configured to classify the historical data and determine a ranking of channels or programs in each class;
a querying module configured to periodically query broadcast information;
a matching module configured to match the broadcast information with the ranking of channels or programs; and
a recommending module configured to recommend to the user a favorite channel or program list with a predetermined degree of match.

7. The system according to claim 6, wherein the ranking module further comprises a fine classification module configured to classify each channel or program in the historical data according to dates and time periods when the user watches the program.

8. The system according to claim 6, wherein the ranking module further comprises a calculating module configured to rank channels and programs in each class according to a user's preference degree.

9. The system according to claim 6, wherein the matching module further comprises a real-time matching module configured to match the current broadcast information with the ranking of channels or programs.

10. The system according to claim 6, wherein the recommending module further comprises a comprehensive recommending module configured to recommend the favorite channel list according to a predetermined degree of match between the current and next broadcast information with the ranking of channels or programs.
